(19) United States
(12) Patent Application Publication
(10) Pub. No.: US 2016/0059309 A1
(43) Pub. Date: Mar. 3, 2016

(54) APPARATUS FOR PRODUCING WORK PIECES WHICH COMPRISES A DRYING DEVICE

(71) Applicant: SLM Solutions Group AG, Luebeck (DE)

(72) Inventors: Frank Junker, Neuss (DE); Stefan Poertner, Moenchengladbach (DE); Dieter Schwarze, Luebeck (DE); Andreas Wiesner, Luebeck (DE)

(21) Appl. No.: 14/842,087

(22) Filed: Sep. 1, 2015

(30) Foreign Application Priority Data
Sep. 3, 2014 (EP) 14183417.6

(51) Int. Cl. B22F 3/105; B28B 17/04; B28B 1/00

(52) U.S. Cl. CPC B22F 3/1055; B28B 1/001; B28B 17/04; B22F 2003/1059; B22F 2003/1056; B33Y 10/00

(57) ABSTRACT

An apparatus (10) for producing three-dimensional work pieces comprises a process chamber (12) accommodating a carrier (16) and a powder application device (14) for applying a raw material powder onto the carrier (16). The apparatus (10) further is equipped with an irradiation device (18) for selectively irradiating electromagnetic or particle radiation onto the raw material powder applied onto the carrier (16) in order to produce a work piece made of said raw material powder by an additive layer construction method. A gas circuit (34) comprises a circulation line (36) adapted to supply gas to the process chamber (12) and to discharge gas loaded with particulate impurities from the process chamber (12), and a raw material powder circuit (42) comprises a circulation line (44) adapted to supply raw material powder to the process chamber (12) and to discharge excess raw material powder from the process chamber (12). A drying device (58, 60) which contains a drying agent is arranged in at least one of the gas circuit (34) and the raw material powder circuit (42).

The invention relates to an apparatus for producing three-dimensional work pieces by irradiating layers of a raw material powder with electromagnetic or particle radiation. Further, the invention relates to a method of operating such an apparatus for producing three-dimensional work pieces by irradiating layers of a raw material powder with electromagnetic or particle radiation.

Powder bed fusion is an additive layering process by which pulverulent, in particular metallic and/or ceramic raw materials can be processed to three-dimensional work pieces of complex shapes. To that end, a raw material powder layer is applied onto a carrier and subjected to laser radiation in a site selective manner in dependence on the desired geometry of the work piece that is to be produced. The laser radiation penetrating into the powder layer causes heating and consequently melting or sintering of the raw material powder particles. Further raw material powder layers are then applied successively to the layer on the carrier that has already been subjected to laser treatment, until the work piece has the desired shape and size. An apparatus for producing moulded bodies from pulverulent raw materials by a powder bed fusion process is described, for example, in EP 1 793 979 B1. Powder bed fusion may be employed for the production of prototypes, tools, replacement parts, high value components or medical prostheses, such as, for example, dental or orthopaedic prostheses, on the basis of CAD data.

The prior art apparatus comprises a process chamber which accommodates a plurality of carriers for the shaped bodies to be manufactured. A powder layer preparation system comprises a powder reservoir holder that can be moved to and fro across the carriers in order to apply a raw material powder to be irradiated with a laser beam onto the carriers. The process chamber is provided with a protective gas inlet and a protective gas outlet which are connected to a protective gas circuit. Via the protective gas inlet, a protective gas such as, for example, Argon is supplied to the process chamber in order to establish a protective gas atmosphere within the process chamber. Via the protective gas outlet, protective gas which, upon flowing through the process chamber, is loaded with particulate impurities such as, for example, residual raw material powder particles and welding smoke particles is be withdrawn from the process chamber.

Within the protective gas circuit, a filter device is arranged which serves to filter the particulate impurities from the protective gas flowing though the protective gas circuit prior to the protective gas being recirculated to the process chamber via the protective gas inlet. When a filter medium provided in the filter device is loaded with particles separated from the protective gas stream flowing though the protective gas circuit, operation of the apparatus is ceased and the filter medium is exchanged. During exchange of the filter medium, ambient air and hence humidity contained in the ambient air enters the protective gas circuit.

The invention is directed at the object of providing an apparatus for producing three-dimensional work pieces by irradiating layers of a raw material powder with electromagnetic or particle radiation which can be operated in a reliable manner and which allows the production of high-quality work pieces. Further, the invention is directed at the object of providing a method of operating an apparatus of this kind.

These objects are addressed by an apparatus as defined in claim 1 and a method as defined in claim 7.

An apparatus for producing three-dimensional work pieces comprises a process chamber accommodating a carrier and a powder application device for applying a raw material powder onto the carrier. In principle, the carrier may be rigidly fixed carrier. Preferably, however, the carrier is designed to be displaceable in vertical direction so that, with increasing construction height of a work piece, as it is built up in layers from the raw material powder, the carrier can be moved downwards in the vertical direction. The raw material powder preferably is a metallic powder, in particular a metal alloy powder, but may also be a ceramic powder or a powder containing different materials. The powder may have any suitable particle size or particle size distribution. It is, however, preferable to process powders of particle sizes <100 μm.

The apparatus further comprises an irradiation device for selectively irradiating electromagnetic or particle radiation onto the raw material powder applied onto the carrier in order to produce a work piece made of said raw material powder by an additive layer construction method. Hence, the raw material powder applied onto the carrier may be subjected to electromagnetic or particle radiation in a site-selective manner in dependence on the desired geometry of the work piece that is to be produced. The irradiation device preferably is adapted to irradiate radiation onto the raw material powder which causes a site-selective melting of the raw material powder particles. The irradiation device may comprise at least one radiation source, in particular a laser source, and at least one optical unit for guiding and/or processing a radiation beam emitted by the radiation source. The optical unit may comprise optical elements such an object lens, in particular and f-theta lens, and a scanner unit, the scanner unit preferably comprising a diffractive optical element and a deflection mirror.

The apparatus for producing three-dimensional work pieces further comprises a gas circuit comprising a circulation line adapted to supply gas to the process chamber and to discharge gas loaded with particulate impurities from the process chamber. For example, a first end of the circulation line may be connected to a gas inlet of the process chamber via which a gas, for example, an inert gas may be supplied to the process chamber. A second end of the circulation line may be connected to a gas outlet of the process chamber. While the raw material powder applied onto the carrier is selectively irradiated with electromagnetic or particle radiation, gas containing particulate impurities such as, for example, raw material powder particles or welding smoke particles thus may be discharged from the process chamber via the gas outlet. The particulate impurities are removed from the process chamber in order to avoid excessive absorption of radiation energy and/or shielding of the radiation beam emitted by the radiation source of the irradiation device.

Preferably, the process chamber is sealable against the ambient atmosphere, i.e. against the environment surrounding the process chamber, in order to be able to maintain a controlled atmosphere, in particular an inert atmosphere within the process chamber. Thus, for example, an Argon atmosphere or any other suitable inert gas atmosphere may be established within the process chamber. By controlling the atmosphere within the process chamber, the occurrence of undesired chemical reactions, in particular oxidation reactions, upon irradiating the raw material powder with electromagnetic or particle radiation can be prevented.

The gas stream may be conveyed through the circulation line of the gas circuit and the process chamber by means of a suitable conveying device such as, for example, a pump. Furthermore, a filter system may be arranged in the circulation line of the gas circuit. This allows particulate impurities present in the gas stream upon exiting the process chamber to be removed from the gas stream before the gas is recirculated to the process chamber. The conveying device for conveying the gas through the circulation line of the gas circuit preferably is arranged in the circulation line downstream of the filter system thus ensuring that the conveying device is not exposed to the particulate impurities present in the gas stream upstream of the filter system.

The apparatus for producing three-dimensional work pieces further comprises a raw material powder circuit comprising a circulation line adapted to supply raw material powder to the process chamber and to discharge excess raw material powder from the process chamber. For example, a first end of the circulation line may be connected to a raw material powder inlet of the powder application device via which raw material powder may be supplied to the powder application device and hence the process chamber. A second end of the circulation line may be connected to a raw material powder outlet of the process chamber. For example, the raw material powder outlet of the process chamber may be provided in an extraction hose which extends into the interior of the process chamber and which may be guided over the carrier as desired so as to withdraw excess raw material powder from the process chamber.

The raw material powder may be conveyed through the circulation line by means of a suitable conveying device such as, for example, a blower. Furthermore, a raw material powder processing system which may comprise a screen and/or filter arrangement may be arranged in the circulation line. A raw material powder processing system disposed in the circulation line of the raw material powder circuit serves to remove coarse particles which may, for example, be formed when raw material powder particles melt upon being irradiated with electromagnetic or particle radiation within the process chamber from the raw material powder before the raw material powder is recirculated to the process chamber and re-used for building up a work piece. The conveying device for conveying the raw material powder through the circulation line of the raw material powder circuit preferably is arranged in the circulation line downstream of the raw material powder processing system thus ensuring that the conveying device is not exposed to the coarse particles contained in the raw material powder upstream of the raw material powder processing system.

Finally, in the apparatus for producing three-dimensional work pieces, a drying device which contains a drying agent is arranged in at least one of the gas circuit and the raw material powder circuit. By providing a drying device in at least one of the gas circuit and the raw material powder circuit, residual humidity present in the raw material powder when the raw material powder is supplied to the raw material powder circuit may be removed in an effective manner. In addition, the drying device is effective in removing humidity which inevitably enters the apparatus when a filter medium provided in a filter system disposed in the circulation line of the gas circuit is exchanged.

In the apparatus, the humidity induced formation of raw material powder agglomerates can be avoided or at least significantly reduced. As a result, the processing properties of the raw material powder upon conveying of the raw material powder through the raw material powder circuit and upon applying the raw material powder onto the carrier can be enhanced. In addition, measurement errors which might occur upon measuring processing parameters relevant for the operational control of the apparatus when humidity induced raw material powder agglomerates are present in the raw material powder can be minimized. Thus, by providing a drying device in at least one of the gas circuit and the raw material powder circuit of the apparatus for producing three-dimensional work pieces, the operational reliability of the apparatus can be enhanced.

Moreover, the apparatus allows the production of high-quality work pieces, in particular with enhanced mechanical properties, since the reduction of the humidity within the apparatus, which is achieved by the provision of the drying device, leads to a reduction of hydrogen induced porosity in the three-dimensional work pieces to be generated by means of the apparatus. Furthermore, also raw material powders having a high affinity to hydrogen, e.g. due to a high solubility of hydrogen in the melt of the raw material powders, and hence are prone to the formation of hydrogen induced porosity such as, for example, Aluminum, by means of the apparatus, can be processed to high-quality work pieces.

The drying device employed in the apparatus for producing three-dimensional work pieces may comprise a humidity permeable container which is filled with the drying agent. For example, the humidity permeable container may be made of a rigid, solid material, such as, for example, a plastic, ceramic or metallic material which is provided with openings in order to allow humidity to enter the container and to adsorb to the drying agent. As an alternative, it is, however, also conceivable to provide the drying device with a humidity permeable container which is made of a fabric, plastic or metallic mesh.

In a preferred embodiment, the drying agent contained in the drying device is silica gel. Silica gel is a highly effective drying agent and, simultaneously, is easy and cheap to obtain. Of course, it is also conceivable to use another suitable drying agent in the drying device of the apparatus as long as undesired physical and/or chemical reactions between the drying agent and materials present in the gas circuit and/or raw material powder circuit such as the gas circulating through the gas circuit and/or the raw material powder circulating through the raw material powder circuit are avoided and as long as the drying agent is capable to withstand the temperatures and the further environmental conditions prevailing in the gas circuit and/or raw material powder circuit.

In the apparatus for producing three-dimensional work pieces, a first drying device may be arranged in the gas circuit in at least one of the circulation line and the process chamber. Usually, the process chamber provides enough space for installing at least one first drying device, which serves to remove humidity from the gas atmosphere prevailing in the process chamber. For example, the first drying device may be arranged in a region of the process chamber which defines a flow path for the gas which is supplied to the process chamber via the gas inlet of the process chamber and which is withdrawn from the process chamber via the gas outlet of the process chamber. A first drying device which is arranged directly in the process chamber is particularly effective in removing humidity from the gas atmosphere within the process chamber, in particular in case the process chamber is not only supplied with gas via the circulation line of the gas circuit, but also with additional gas which is supplied to the process chamber, for example from an external gas source, independent of the gas circuit. However, a first drying device arranged in the process chamber, of course, not necessarily exclusively adsorbs humidity present in the gas atmosphere within the process chamber, but also may remove humidity from in the raw material powder processed within the process chamber.

A first drying device which is arranged in the circulation line of the gas circuit is protected from being directly influenced by the processing conditions within the process chamber, in particular large amounts of raw material powder, high temperatures, welding smoke generated upon selectively irradiating the raw material powder and possibly also radiation emitted by the irradiation device, and is particularly effective in removing humidity from gas exiting the process chamber before the gas is recirculated into the process chamber. Of course, if desired, the apparatus may be provided with plural first drying devices which may be arranged in the circulation line of the gas circuit and/or the process chamber.

As already indicated above, a filter may be arranged in the circulation line of the gas circuit so as to remove particulate impurities from the gas stream exiting the process chamber. A first drying device arranged in the circulation line of the gas circuit may be arranged in said filter. For example, the first drying device may be disposed in a freely suspended manner in a cylinder portion of the filter arranged in the circulation line of the gas circuit. Within the filter, there is enough installation space for the first drying device. Furthermore, a first drying device arranged in a filter disposed in the circulation line of the gas circuit is particularly effective in removing humidity which is introduced into the gas circuit upon exchanging a filter medium of the filter.

A second drying device may be arranged in the raw material powder circuit in at least one of the circulation line and the process chamber. Like in the case of the first drying device, the process chamber also provides enough installation space for a second drying device. The second drying device which is arranged in the process chamber and serves to remove humidity from the raw material powder present in the process chamber, however, preferably is arranged close to the carrier for receiving the raw material powder which typically is arranged in a lower region of the process chamber, i.e. in close proximity to the raw material powder to be dried. While a second drying device arranged in the process chamber is particularly effective in removing humidity from the raw material powder present in the process chamber, the second drying device, however, also may be effective for drying the gas atmosphere within the process chamber.

A second drying device which is arranged in the circulation line of the raw material powder circuit is protected from being directly influenced by the processing conditions within the process chamber, in particular large amounts of raw material powder, high temperatures, welding smoke generated upon selectively irradiating the raw material powder and possibly also radiation emitted by the irradiation device and is particularly effective in removing humidity from excess raw material powder which is withdrawn from the process chamber before the raw material powder is recirculated into the process chamber. The second drying device may be disposed in the region of a raw material powder inlet for supplying raw material powder to the process chamber and/or in the region of a raw material powder outlet for discharging raw material powder from the process chamber. It is, however, also conceivable to arrange a second drying device in a raw material powder processing system which is disposed in the circulation line of the raw material powder circuit for removing coarse particles from the raw material powder before being recirculated to the process chamber.

In a method for operating an apparatus for producing three-dimensional work pieces, a raw material powder is applied onto a carrier accommodated within a process chamber. Electromagnetic or particle radiation is selectively irradiated onto the raw material powder applied onto the carrier in order to produce a work piece made of said raw material powder by an additive layer construction method. Gas is supplied to the process chamber via a circulation line of a gas circuit. Gas loaded with particulate impurities is discharged from the process chamber via the circulation line of the gas circuit. Raw material powder is supplied to the process chamber via a circulation line of a raw material powder circuit. Excess raw material powder is discharged from a process chamber via the circulation line of the raw material powder circuit. At least one of the gas circulating in the gas circuit and the raw material powder circulating in the raw material powder circuit is dried by means of a drying device which contains a drying agent.

The drying device may comprise a humidity permeable container filled with the drying agent.

The drying agent may be silica gel.

The gas circulating in the gas circuit may be dried by means of a first drying device which is arranged in the gas circuit in at least one of the circulation line and the process chamber.

The gas circulating in the gas circuit may be dried by means of a first drying device which is arranged in a filter arranged in the circulation line of the gas circuit.

The raw material powder circulating in the raw material powder circuit may be dried by means of a second drying device which is arranged in the raw material powder circuit in at least one of the second circulation line and the process chamber.

In the method for operating an apparatus for producing three-dimensional work pieces, raw material powder may be dried before being supplied to the raw material powder circuit from a raw material powder source. For example, the powder may be dried by heating or be freeze-drying. It is, however, also conceivable that raw material powder is dried by means of a drying agent before being supplied to the raw material powder circuit of the apparatus. By ensuring that raw material powder supplied to the apparatus from an external source is dried, the introduction of humidity into the apparatus can be minimized.

Similarly, gas may be dried before being supplied to the gas circuit from a gas source. For example, the gas may be dried by directing the gas through/over a drying agent before being supplied to the gas circuit of the apparatus. Again, by ensuring that gas supplied to the apparatus from an external source is dried, the introduction of humidity into the apparatus can be minimized.

The humidity within the apparatus for producing three-dimensional work pieces can further be reduced when the process chamber, the gas circuit and/or the raw material powder circuit, upon start-up or during operation of the apparatus, is flushed with dried gas for a period of time which is sufficient to displace residual gas containing a higher amount of humidity from the process chamber, the gas circuit and/or the raw material powder circuit. The process of flushing the process chamber, the gas circuit and/or the raw material powder circuit may be performed under the control of a control unit. Said control unit may, for example, be adapted to control (a) conveying device(s) for conveying gas and/or raw material powder to the process chamber, the gas circuit and/or the raw material powder circuit and/or respective valves.

In a preferred embodiment of the method for operating an apparatus for producing three-dimensional work pieces, a filter medium is dried before being installed in a filter arranged in the circulation line of the gas circuit. The amount of humidity which is introduced into the gas circuit upon exchanging the filter medium of the filter arranged in the circulation line of the gas circuit thus can be significantly reduced. In case a raw material powder processing system arranged in the circulation line of the raw material powder circuit also comprises a filter with an exchangeable filter medium, also this filter medium may be dried before being installed in the filter of the raw material powder processing system in order to minimize the introduction of humidity into the raw material powder circuit.

The filter medium may be dried for 5 to 10 hours at a temperature between 80 and 100° C. By drying the filter medium before installation in a filter arranged in the circulation line of the gas circuit overnight in an oven, the relative humidity within the gas circuit can be reduced to below 3% rF and can even reach values around 2% rF.

A preferred embodiment of the invention in the following is explained in greater detail with reference to the accompanying schematic drawing, in which:

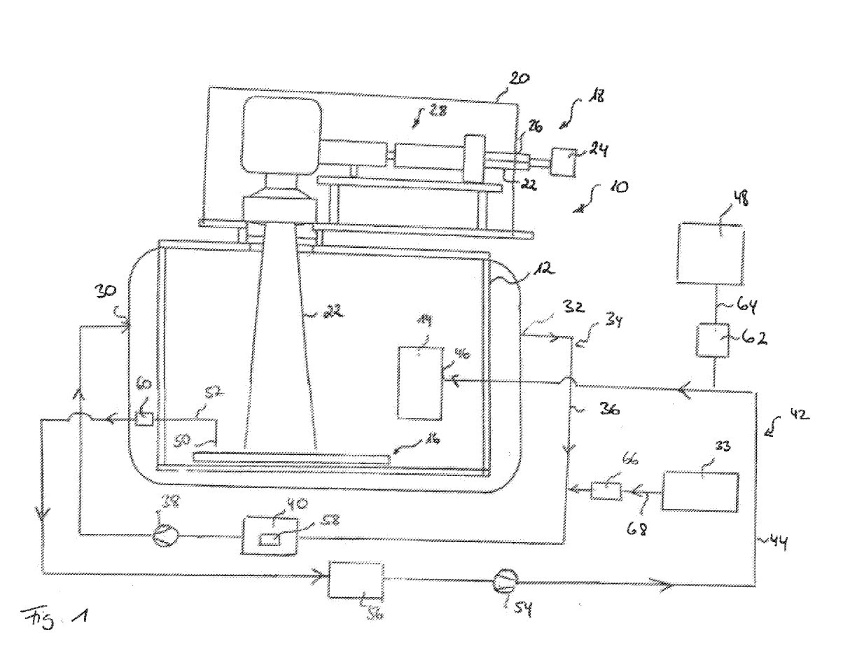

FIG. 1 shows an apparatus for producing three-dimensional work pieces.

FIG. 1 shows an apparatus 10 for manufacturing a component by an additive layer construction method. The apparatus 10 comprises a process chamber 12. A powder application device 14, which is disposed in the process chamber 12, serves to apply a raw material powder onto a carrier 16. The process chamber 12 is sealable against the ambient atmosphere, i.e. against the environment surrounding the process chamber 12. The carrier 16 is designed to be displaceable in a vertical direction so that, with increasing construction height of a component, as it is built up in layers from the raw material powder on the carrier 16, the carrier 16 can be moved downwards in the vertical direction.

The apparatus 10 further comprises an irradiation device 18 for selectively irradiating laser radiation onto the raw material powder applied onto the carrier 16. By means of the irradiation device 18, the raw material powder applied onto the carrier 16 may be subjected to laser radiation in a site-selective manner in dependence on the desired geometry of the component that is to be produced. The irradiation device 18 has a hermetically sealable housing 20. A radiation beam 22, in particular a laser beam, provided by a radiation source 24, in particular a laser source which may, for example, comprise a diode pumped Ytterbium fibre laser emitting laser light at a wavelength of approximately 1070 to 1080 nm is directed into the housing 20 via an opening 26.

The irradiation device 18 further comprises an optical unit 28 for guiding and processing the radiation beam 22. The optical unit 28 may comprise a beam expander for expanding the radiation beam 22, a scanner and an object lens. Alternatively, the optical unit 28 may comprise a beam expander including a focusing optic and a scanner unit. By means of the scanner unit, the position of the focus of the radiation beam 22 both in the direction of the beam path and in a plane perpendicular to the beam path can be changed and adapted. The scanner unit may be designed in the form of a galvanometer scanner and the object lens may be an f-theta object lens.

During operation of the apparatus 10, a first layer of a component to be produced is generated on the carrier 16 by selectively irradiating the raw material powder layer applied onto the carrier 16 with the radiation beam 22. The radiation beam 22 is directed over the raw material powder layer applied onto the carrier 16 in accordance with CAD data of the component to be produced. After the first layer of the component to be produced is completed, the carrier 16 is lowered in a vertical direction allowing the application of a successive powder layer by means of the powder application device 14. Thereafter, the successive powder layer is irradiated by means of the irradiation device 18. Thus, layer by layer, the component is built up on the carrier 16.

The process chamber 12 is provided with a gas inlet 30 and a gas outlet 32. Via the gas inlet 30, a gas, for example an inert gas, provided by an inert gas source 33 is supplied to the process chamber 12. Within the process chamber 12, the gas stream takes up particulate impurities such as raw material powder particles and combustion products such as, for example, welding smoke and soot particles. Therefore, at the gas outlet 32 of the process chamber, a gas stream containing particulate impurities is discharged from the process chamber 12. The gas/particle mixture exiting the process chamber 12 is supplied to a circulation line 36 connecting the gas outlet 32 of the process chamber 12 to the gas inlet 30 of the process chamber 12. Via the circulation line 36, gas discharged from the process chamber 12 via the gas outlet 32 can be recirculated to the process chamber 12.

Thus, a gas circuit 34 is defined by the process chamber 12, i.e. a region of the process chamber 12 defining a flow path for the gas through the process chamber 12, and the circulation line 36. A conveying device 38 which is designed in the form of a pump and which is arranged in the circulation line 36 serves to convey the gas/particle mixture exiting the process chamber 12 via the gas outlet 32 through the circulation line 36. In order to avoid excessive absorption of radiation energy and/or shielding of the radiation beam 22 emitted by the radiation source 24 of the irradiation device 18, the particulate impurities which are present in the gas stream exiting the process chamber 12 via the gas outlet 32 are removed from the gas stream before the gas stream is recirculated to the process chamber 12 via the gas inlet 30 by means of a filter system 40 which is arranged in the circulation line 36 upstream of the conveying device 38.

The apparatus 10 further comprises a raw material powder circuit 42 defined by the process chamber 12 and a circulation line 44. A first end of the circulation line 44 is connected to a raw material powder inlet 46 of the powder application device 14 so as to supply raw material powder provided by a raw material powder 46 to the powder application device 14 and hence the process chamber 12. A second end of the circulation line 44 is connected to a raw material powder outlet 50 of the process chamber. In the embodiment of an apparatus 10 shown in FIG. 1, the raw material powder outlet 50 of the process chamber 12 is provided in a flexible extraction hose 52 which extends into the interior of the process chamber 12 and which may be guided over the carrier 16 as desired so as to withdraw excess raw material powder from the process chamber 12.

The raw material powder is conveyed through the circulation line 44 of the raw material powder circuit 42 by means of a conveying device 54 designed in the form of blower. Furthermore, a raw material powder processing system 56 which comprised a screen arrangement is arranged in the circulation line 44 for removing coarse particles from the raw material powder discharged from the process chamber 12 before the raw material powder is recirculated to the process chamber 12 and re-used for building up a work piece. The conveying device 54 for conveying the raw material powder through the circulation line 44 of the raw material powder circuit 42 is arranged in the circulation line 44 downstream of the raw material powder processing system 56.

In the apparatus 10 for producing three-dimensional work pieces, a first and a second drying device 58, 60 are arranged in the gas circuit 34 and the raw material powder circuit 42, respectively. Specifically, the first drying device 58 is arranged in the filter 40 disposed in the circulation line 36 of the gas circuit 34. The second drying device 60 is arranged in the circulation line 52 of the raw material powder circuit 42 in the region of the raw material powder outlet 50. While the first drying device 58 is particularly effective in removing humidity from the gas stream flowing through the gas circuit 34 and specifically from a filter medium installed in the filter 40, the second drying device 60 mainly serves to remove humidity from the raw material powder discharged from the process chamber 12 before the raw material powder is recirculated to the process chamber 12.

Further, the apparatus 10 comprises a third drying device 62 which is arranged in a supply line 64 connecting the raw material powder source 48 to the raw material powder circuit 42 and which serves to dry the raw material powder supplied by the raw material powder source 48 before being introduced into the raw material powder circuit 42. Additionally or alternatively thereto, the raw material powder may be dried before being supplied to the raw material powder circuit 42 by heating or be freeze-drying. In addition, a fourth drying device 66 is arranged in a supply line 68 connecting the gas source 33 to the gas circuit 34 which serves to dry the gas supplied by the gas source 33 before being introduced into the gas circuit 34.

Each of the drying devices 58, 60, 62, 66 employed in the apparatus 10 for producing three-dimensional work pieces comprises a humidity permeable container which is filled with a drying agent. In particular, silica gel may be used as the drying agent in the drying devices 58, 60, 62, 66.

By providing the apparatus 10 with the drying devices 58, 60, 62, 66, the amount of humidity which present in the apparatus 10 and the amount of humidity which is introduced into the apparatus 10 can be minimized. As a result, the operational reliability of the apparatus 10 and the quality of the generated work pieces can be enhanced.

In order to further reduce the humidity present within the apparatus 10, the process chamber 12, the gas circuit 34 and the raw material powder circuit 42, upon start-up of the apparatus 10, is flushed with dried gas from the gas source 33 for a period of time which is sufficient to displace residual gas containing a higher amount of humidity from the process chamber 12, the gas circuit 34 and the raw material powder circuit 42. In addition, a filter medium is dried before being installed in the filter 40 arranged in the circulation line 36 of the gas circuit 34. The amount of humidity which is introduced into the gas circuit 34 upon exchanging the filter medium of the filter 40 thus can be significantly reduced. Specifically, the filter medium may be dried for 5 to 10 hours at a temperature between 80 and 100° C.

1. Apparatus for producing three-dimensional work pieces, the apparatus comprising:
a process chamber accommodating a carrier and a powder application device for applying a raw material powder onto the carrier,
an irradiation device for selectively irradiating electromagnetic or particle radiation onto the raw material powder applied onto the carrier in order to produce a work piece made of said raw material powder by an additive layer construction method,
a gas circuit comprising a circulation line adapted to supply gas to the process chamber and to discharge gas loaded with particulate impurities from the process chamber, and
a raw material powder circuit comprising a circulation line adapted to supply raw material powder to the process chamber and to discharge excess raw material powder from the process chamber,
characterized in that a drying device which contains a drying agent is arranged in at least one of the gas circuit and the raw material powder circuit.

2. Apparatus according to claim 1,
wherein the drying device comprises a humidity permeable container filled with the drying agent.

3. Apparatus according to claim 1,
wherein the drying agent is silica gel.

4. Apparatus according to claim 1,
wherein a first drying device is arranged in the gas circuit in at least one of the circulation line and the process chamber.

5. Apparatus according to claim 4,
wherein a filter is arranged in the circulation line of the gas circuit and a first drying device is arranged in the filter.

6. Apparatus according to claim 1,
wherein a second drying device is arranged in the raw material powder circuit in at least one of the circulation line and the process chamber.

7. Method for operating an apparatus for producing three-dimensional work pieces, comprising:
applying a raw material powder onto a carrier accommodated within a process chamber,
selectively irradiating electromagnetic or particle radiation onto the raw material powder applied onto the carrier in order to produce a work piece made of said raw material powder by an additive layer construction method,
supplying gas to the process chamber via a circulation line of a gas circuit and discharging gas loaded with particulate impurities from the process chamber via the circulation line of the gas circuit, and
supplying raw material powder to the process chamber via a circulation line of a raw material powder circuit and discharging excess raw material powder from the process chamber via the circulation line of the raw material powder circuit,
characterized in that at least one of the gas circulating in the gas circuit and the raw material powder circulating in the raw material powder circuit is dried by means of a drying device which contains a drying agent.

8. Method according to claim 7,
wherein the drying device comprises a humidity permeable container filled with the drying agent.

9. Method according to claim 7,
wherein the drying agent is silica gel.

10. Method according to claim 7,
wherein the gas circulating in the gas circuit is dried by means of a first drying device which is arranged in the gas circuit in at least one of the circulation line and the process chamber.

11. Method according to claim 10,
wherein the gas circulating in the gas circuit is dried by means of a first drying device which is arranged in a filter arranged in the circulation line of the gas circuit.

12. Method according to claim 7,
wherein the raw material powder circulating in the raw material powder circuit is dried by means of a second drying device which is arranged in the raw material powder circuit in at least one of the circulation line and the process chamber.

13. Method according to claim 7,
wherein raw material powder is dried before being supplied to the raw material powder circuit from a raw material powder source and/or wherein gas is dried before being supplied to the gas circuit from a gas source.

14. Method according to claim 7,
wherein a filter medium is dried before being installed in a filter arranged in the circulation line of the gas circuit.

15. Method according to claim 14,
wherein the filter medium is dried for 5 to 10 hours at a temperature between 80 and 100° C.
